(19) United States
(12) Patent Application Publication
(10) Pub. No.: US 2007/0030201 A1
(43) Pub. Date: Feb. 8, 2007

(54) Antenna device

(75) Inventor: Hao-Chun Tung, Chinmen Hsien (TW)

Correspondence Address: LADAS & PARRY, 26 WEST 61ST STREET, NEW YORK, NY, 10023, US

(73) Assignee: BENQ CORPORATION

(21) Appl. No.: 11/126,599

(22) Filed: May 11, 2005

(30) Foreign Application Priority Data
May 11, 2004 (TW) 93113144

(51) Int. Cl. H01Q 1/24

(52) U.S. Cl. 343/702; 343/895

(57) ABSTRACT

An antenna device is for a mobile unit to transmit/receive signals, and the mobile unit comprises a printed circuit board which is mounted with a signal processing circuit for processing the signals, the antenna device comprises an antenna body, a metal feeding line, and a ground metal layer. The antenna body is mounted on one side of the mobile unit for transmitting/receiving signals. The metal feeding line made on the upper surface of the printed circuit board, one end of the metal feeding line is connected to the antenna body and the other end of the metal feeding line is in connection with the signal processing circuit from the center part of an edge of the printed circuit board. The ground metal layer is formed on the lower surface of the printed circuit board. When the mobile unit is in transmission, as a result of the metal feeding line is fed from the center part of the edge of the printed circuit board to the signal processing circuit that the well-spread currents are generated upon the surface of the ground metal layer and the antenna device has omnidirectional antenna radiation pattern.

### BACKGROUND OF THE INVENTION

(1) Field of the Invention

The invention relates to an antenna device, and more particularly to an antenna device used for a mobile unit.

(2) Description of the Prior Art

With current developments in communication technology, many electronic devices need antennas which can receive and transmit signals in two frequency ranges (dual mode), three frequency ranges (triple mode), or more. Commercially, some of major concerns upon those multi-band products are their efficiency, appearance, size, etc. Actually in most communication devices, the efficiency of signal transmission is the most important of all. In particular, the performance of the antenna in the communication device takes a major share to the efficiency of signal transmission. Generally, to achieve a modern appearance design of the communication device without sacrificing the efficiency of antenna has become the major goal to most designers in this industry.

However, there have various types of cell phone in the market. To take the shell phone for example, the spiral antenna is the most adopted antenna type for shell phones. When the spiral antenna is used for shell phones, there occurred some problems in high frequency operation. Referring to FIG. 1, the antenna device 10 is set on one side of the shell phone. The feed point 16 of the antenna device 10 located on the edge portion of the print circuit board 24 of the shell phone and fed through a metal feeding line 18 to the connection point 20 and then through a metal strip or a connector to connect the connection point 20 (e.g. antenna connector 14).

Especially, when operating at DCS frequency band (range from 1710 MHz to 1880 MHz), the shell phone who use this kind of antenna may cause an un-omnidirectional antenna radiation pattern because of uneven surface current distribution on the grounding plane 22. As shown in FIG. 2, a simulation pattern illustrates the antenna device in FIG. 1 operating at 1800 MHz. The defect of transmission angle of the antenna device locates on the left side of the shell phone because of the defect of radiation pattern occurs in y axis of y-z plane and further causes the efficiency drop of the phone.

Therefore, in order to improve the foregoing disadvantages, the present invention provides an antenna device which has an omnidirectional antenna radiation pattern and to upgrade the transmission efficiency of the antenna device.

### SUMMARY OF THE INVENTION

Accordingly, it is an object of the present invention to provide an antenna device which has a metal feeding line feeding from the center part of the printed circuit board of the mobile unit so as to have a better radiation character as transmission at high frequency for the antenna device.

The present invention provides an antenna device which is for a mobile unit (e.g. mobile phone) to transmit/receive signals. The mobile unit comprises a printed circuit board (PCB) which is mounted with a signal processing circuit for processing the signals. The antenna device comprises a spiral body, a metal feeding line, and a ground metal layer. The spiral body mounted on one side of the mobile phone for transmitting/receiving signals. Besides, the spiral body can further include an antenna connector. The metal feeding line made on the upper surface of the PCB where one end of the metal feeding line can be connected to the spiral body and the other end of the metal feeding line can be in connection with the signal processing circuit from the center part of an edge of the PCB.

The ground metal layer can be formed on the lower surface of the PCB. When the mobile phone is in transmission, as a result of the metal feeding line is fed from the center part of the edge of the PCB to the signal processing circuit that the well-spread currents can be generated upon the surface of the ground metal layer and the antenna device has omnidirectional antenna radiation pattern.

### BRIEF DESCRIPTION OF THE DRAWINGS

The present invention will now be specified with reference to its preferred embodiment illustrated in the drawings, in which

FIG. 1 is a schematic view with a conventional mobile phone and the antenna device positioned on one side of the mobile phone;

FIG. 2 is a radiation pattern of the antenna device of FIG. 1 operating at 1.8 GHz;

FIG. 3 is a schematic view of the mobile phone and the antenna device positioned on one side of the mobile phone in accordance with the preferred embodiment of the present invention;

FIG. 4 is a radiation pattern of the antenna device of FIG. 3 operating at 1.8 GHz;

FIG. 5 is a diagram of computer-simulation results illustrating the input return loss versus frequency for the preferred embodiment of the present invention; and

FIG. 6a˜6d are schematic views of other embodiments in accordance with the present invention.

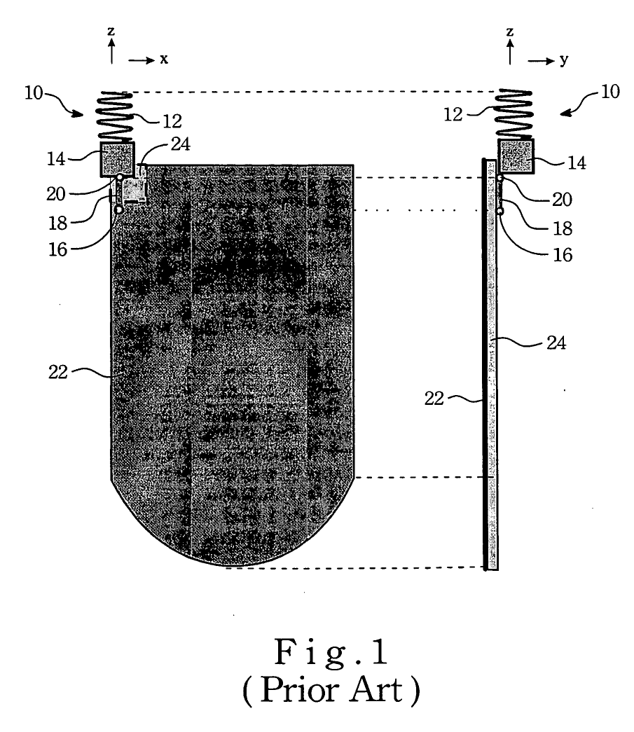

### DESCRIPTION OF THE PREFERRED EMBODIMENT

The invention disclosed herein is to provide an antenna device, and more particularly to provide an antenna device used in mobile unit. In the present invention, it is provided an antenna device which has a metal feeding line feeding from the center part of the printed circuit board (PCB) of the mobile unit so as to have a better radiation character as transmission at high frequency for the antenna device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

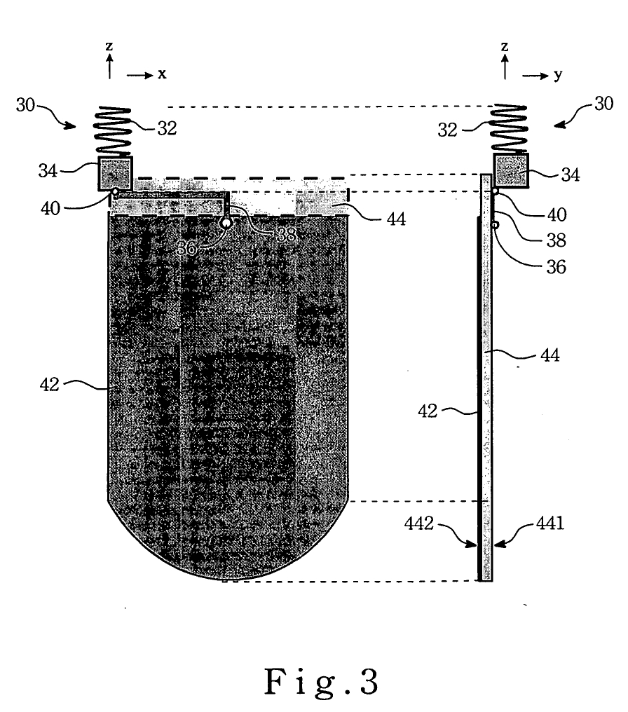

Referring to FIG. 3, a schematic view illustrates an antenna device with the relating mobile unit (e.g. cell phone) in accordance with the preferred embodiment to the present invention. In the invention, the cell phone can include at least an antenna device 30 and a printed circuit board (PCB) 44. Besides, a signal processing circuit (not shown in the drawing) which is used to process received and transmitting signals can be mounted on the upper surface of the PCB 44. The antenna device 30 for transmitting/receiving signals may include an antenna body 32, a metal feeding line 38, and a ground metal layer 42. In addition, the antenna body 32 can include an antenna connector 34. The antenna body 32 for transmitting/receiving signals can be fixed through the antenna connector 34 on one side of the PCB 44 of the cell phone.

The metal feeding line 38 can be made with the other circuitry on the upper surface of the PCB 44. It should be noted that one end of the metal feeding line 38 can connect to the antenna body 32 through the antenna connector 34 by connecting an antenna connection point 40. The other end of the metal feeding line 38 can be in connection with the signal processing circuit (not shown in the drawing) via a feed point 36 from the center part of upper side of the PCB 44. It is to be noted that to adjust the feeding position of the metal feeding line 38 may influence the resonance frequency for the antenna device 30. This is because the equivalent length of the antenna is restricted by its operating frequency. Typically, the equivalent length of the entire antenna (including the antenna body 32, the antenna connector 34 and the metal feeding line 38) should be one quarter of the wavelength for the operating frequency of the antenna. Additionally, as shown in the drawing, spiral antenna is used for the antenna body 32 in this embodiment, other types of antenna are well known to the skilled person in the art and definitely any intent to include such a modification shall be within the scope of this invention.

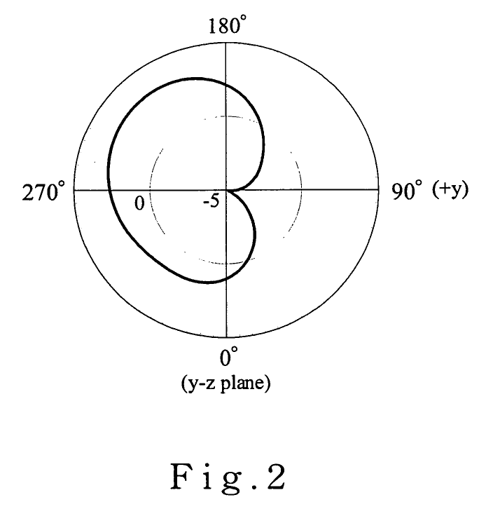

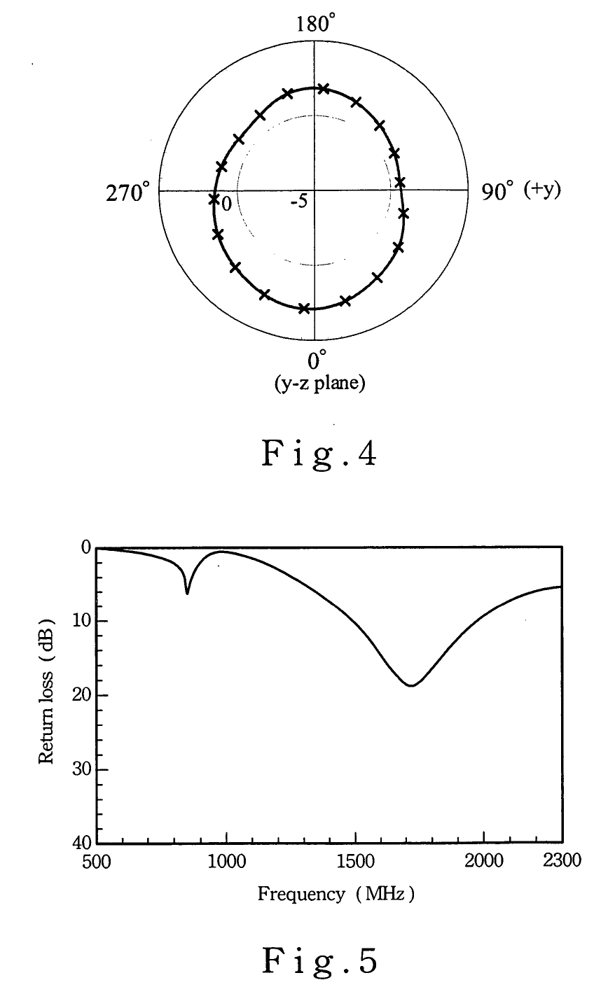

Moreover, the ground metal layer 42 can be formed on the lower surface of the PCB 44. Therefore, when the cell phone is in transmission, as a result of the metal feeding line 38 is fed from the center part of the upper side of the PCB 44 to the signal processing circuit that the well-spread currents are generated upon the surface of the ground metal layer 42 and the antenna device 30 can induce omnidirectional antenna radiation. Referring to FIG. 4, a radiation pattern illustrates the antenna device of FIG. 3 operating at 1.8 GHz. The size of major elements of the antenna device is illustrated below: the radius and height of the antenna body 32 are separately 3 mm and 5.5 mm; the volume of the PCB 44 is 80×40×2 mm³; the antenna connector 34 is a copper pillar with 3 mm height. As shown in the drawing, the defect of radiation pattern on the y-z plane for the prior art antenna (referring to FIG. 2) is not shown in this embodiment.

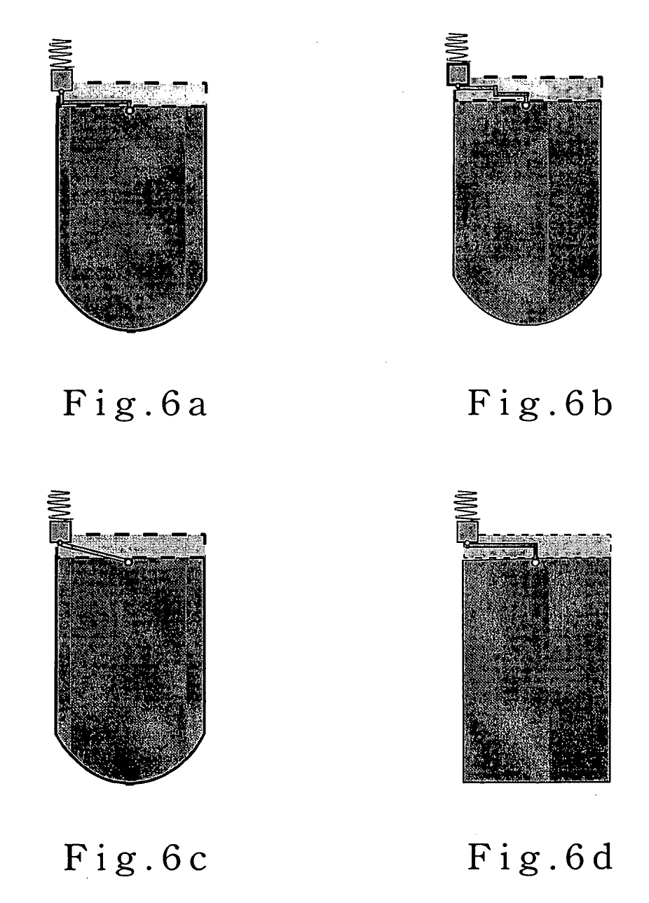

Referring to FIG. 5, a diagram of computer-simulation results illustrates the input return loss versus frequency for the preferred embodiment of the present invention. By means of adjusting the length of the metal feeding line 38, the antenna device can remain operation in GSM and DCS system (frequency band of GSM system ranges from 880 MHz to 960 MHz; frequency band of DCS system ranges from 1710 MHz to 1880 MHz). Furthermore, FIG. 6a˜6d are schematic views of other embodiments in accordance with the present invention. Especially in FIGS. 6a, 6b, and 6d where the metal feeding lines 38 are angulated more than one right angles. However, the length of the metal feeding line 38 should restrict in one quarter of wavelength for the operating frequency.

In summary, the present invention provides at least the following advantages over the conventional techniques:

(1) There is no other additional elements to add in the original antenna device including the changeless outline of the mobile unit that can improve the defect of radiation pattern occurred prior to the original antenna design.

(2) By means of changing the feeding position of the metal feeding line connecting between the antenna body and the signal processing circuit, the antenna can induce approximately omnidirectional radiation pattern at high frequency operation and upgrade the signal transmission efficiency of the antenna.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. An antenna device for a mobile unit to transmit/receive signals, the mobile unit having a printed circuit board mounted a signal processing circuit for processing the signals, the antenna device comprising:
an antenna body mounted on one side of the mobile unit for transmitting/receiving signals;
a metal feeding line made on the upper surface of the printed circuit board, one end of said metal feeding line connected to said antenna body and the other end of said metal feeding line connected to said signal processing circuit from the center part of an edge of said printed circuit board; and
a metal layer formed on the lower surface of said printed circuit board;
wherein when the mobile unit is in transmission, as a result of said metal feeding line is fed from the center part of the edge of said printed circuit board to said signal processing circuit that the well-spread currents are generated upon the surface of said ground metal layer and said antenna device having omnidirectional antenna radiation pattern.

2. The antenna device according to claim 1, wherein said antenna body is a spiral antenna.

3. The antenna device according to claim 2, wherein said spiral antenna further comprises an antenna connector which is used for connecting said spiral antenna and said metal feeding line.

4. The antenna device according to claim 1, wherein said mobile unit is a mobile phone.

5. The antenna device according to claim 1, wherein said metal feeding line is angulated more than one right angles.

6. A mobile unit comprising:
a printed circuit board;
a signal processing circuit mounted on the upper surface of said printed circuit board; and
an antenna device for transmitting/receiving signals, wherein the antenna device further comprising:
an antenna body mounted on one side of the mobile unit for transmitting/receiving signals;
a metal feeding line made on the upper surface of the printed circuit board, one end of said metal feeding line is connected to said antenna body and the other end of said metal feeding line connected to said signal processing circuit from the center part of an edge of said printed circuit board; and
a ground metal layer formed on the lower surface of said printed circuit board;
wherein when the mobile unit is in transmission, as a result of said metal feeding line is fed from the center part of the edge of said printed circuit board to said signal processing circuit that the well-spread currents are generated upon the surface of said ground metal layer and said antenna device having omnidirectional antenna radiation pattern.

7. The mobile unit according to claim 6, wherein said antenna body is a spiral antenna.

8. The mobile unit according to claim 7, wherein said spiral antenna further comprises an antenna connector which is used for connecting said spiral antenna and said metal feeding line.

9. The mobile unit according to claim 6, wherein said mobile unit is a mobile phone.

10. The mobile unit according to claim 6, wherein said metal feeding line is angulated more than one right angles.
